(19) United States
(12) Patent Application Publication
(10) Pub. No.: US 2012/0229543 A1
(43) Pub. Date: Sep. 13, 2012

(54) FLUID EJECTING APPARATUS

(75) Inventor: Toshihiro HAYASHI, Matsumoto-shi (JP)

(73) Assignee: SEIKO EPSON CORPORATION, Tokyo (JP)

(21) Appl. No.: 13/417,051

(22) Filed: Mar. 9, 2012

(30) Foreign Application Priority Data
Mar. 11, 2011 (JP) 2011-054129

(51) Int. Cl. B41J 29/38

(52) U.S. Cl. 347/10

(57) ABSTRACT

An ink temperature is calculated based on an ink viscosity. In a zone where the ink temperature is less than 15° C., a first value is set to a proportionality coefficient. In a zone where the ink temperature is equal to or higher than 15° C. and is less than 25° C., a second value is set to the proportionality coefficient. In a zone where the ink temperature is equal to or higher than 25° C. and is less than 40° C., a third value is set to the proportionality coefficient. A drive voltage for a printing head (piezoelectric elements) is set by adding a proportionality term proportional to the ink temperature by the proportionality coefficient to a reference value of the drive voltage.

This application claims the benefit of Japanese Application No. 2011-054129, filed Mar. 11, 2011, all of which are hereby incorporated by reference.

### BACKGROUND

1. Technical Field

The present invention relates to a fluid ejecting apparatus that compresses a fluid by driving piezoelectric elements to thereby eject the fluid from nozzles.

2. Related Art

There has been proposed a fluid ejecting apparatus of such a type that causes an electrostatic actuator to vibrate a vibrating plate to contract the volume of a cavity (ink chamber), thereby compressing the ink in the cavity to eject ink droplets from a nozzle communicating with the cavity (see, for example, JP-A-2004-306529). This apparatus detects the viscosity of ink in the ink chamber by detecting the residual vibration of the vibrating plate, and corrects a drive voltage for the electrostatic actuator based on the detected viscosity.

Properly correcting the drive voltage for the electrostatic actuator is considered as one of important factors for a fluid ejecting apparatus to improve the ejection accuracy, thereby forming a more accurate image.

### SUMMARY

An advantage of some aspects of the invention is to provide a fluid ejecting apparatus that properly corrects a drive voltage for piezoelectric elements to eject the fluid more accurately.

The fluid ejecting apparatus according to the advantage is achieved by employing the following configurations.

The fluid ejecting apparatus according to an aspect of the invention compresses a fluid by driving piezoelectric elements to thereby eject the fluid from nozzles, and includes a viscosity estimating unit that estimates a viscosity of the fluid; a drive voltage setting unit that sets a drive voltage for the piezoelectric elements based on the estimated viscosity according to a predetermined relation between the viscosity and a voltage such that the smaller the viscosity is, the higher the voltage becomes; and a drive control unit that controls driving of the piezoelectric elements according to the set drive voltage, wherein the predetermined relation is set in such a way that the voltage increases with a decrease in viscosity by different increasing ratios in two or more zones respectively with a predetermined viscosity being a boundary therebetween.

The fluid ejecting apparatus estimates the viscosity of a fluid, sets the drive voltage for the piezoelectric elements based on the estimated viscosity according to a predetermined relation between the viscosity and a voltage such that the smaller the viscosity is, the higher the voltage becomes, and controls driving of the piezoelectric elements according to the set drive voltage, wherein the predetermined relation is set in such a way that the voltage increases with a decrease in viscosity by different increasing ratios in two or more zones respectively with a predetermined viscosity being a boundary therebetween. This makes it possible to more adequately correct a drive voltage for piezoelectric elements to eject the fluid more accurately regardless of the viscosity of the fluid.

In the fluid ejecting apparatus according to the aspect of the invention, the predetermined relation may be set in such a way that the voltage increases with a decrease in viscosity by a first increasing ratio in a first zone where the viscosity is less than the predetermined viscosity, and the voltage increases with a decrease in viscosity by a second increasing ratio larger than the first increasing ratio in a second zone where the viscosity is equal to or higher than the predetermined viscosity.

In the fluid ejecting apparatus according to the aspect of the invention, the predetermined relation is set in such a way that the drive voltage increases with an increase in temperature by different increasing ratios in two or more zones respectively with a predetermined temperature being a boundary therebetween, and the drive voltage setting unit calculates a temperature of the fluid based on the estimated viscosity of the fluid, and sets the drive voltage for the piezoelectric elements based on the calculated temperature of the fluid according to the predetermined relation.

A fluid ejecting apparatus according to a second aspect of the invention compresses a fluid by driving piezoelectric elements to thereby eject the fluid from nozzles, and includes a viscosity estimating unit that estimates a viscosity of the fluid; a drive voltage setting unit that sets a voltage included in different voltages respectively determined beforehand for zones with a predetermined viscosity being a boundary therebetween, and corresponding to a zone to which the estimated viscosity belongs, as the drive voltage for the piezoelectric elements; and a drive control unit that controls driving of the piezoelectric elements according to the set drive voltage.

The fluid ejecting apparatus according to the second aspect of the invention estimates the viscosity of the fluid, sets a voltage included in different voltages respectively determined beforehand for zones with a predetermined viscosity being a boundary therebetween, and corresponding to a zone to which the estimated viscosity belongs, as the drive voltage for the piezoelectric elements, and controls driving of the piezoelectric elements according to the set drive voltage. This makes it possible to more adequately correct a drive voltage for piezoelectric elements to eject the fluid more accurately regardless of the viscosity of the fluid.

In the fluid ejecting apparatus according to the first aspect or the second aspect of the invention, the predetermined viscosity may be set to 0.00114±0.00001 Pa·s which is a viscosity when the temperature of the fluid is 15° C., may be set to 0.00089±0.00001 Pa·s which is a viscosity when the temperature of the fluid is 25° C., or may be set to 0.00065±0.00001 Pa·s which is a viscosity when the temperature of the fluid is 40° C.

### BRIEF DESCRIPTION OF THE DRAWINGS

The invention will be described with reference to the accompanying drawings, wherein like numbers reference like elements.

FIG. 1 is a schematic configurational diagram of an ink jet printer according to an exemplary embodiment of the invention.

FIG. 2 is a schematic configurational diagram of a printing head.

FIG. 3 is a schematic configurational diagram of a drive circuit that drives the printing head.

FIG. 4 is a schematic configurational diagram of a mask circuit.

FIG. 5 is a flowchart illustrating one example of an ink viscosity detecting routine.

FIG. 6 is a flowchart illustrating one example of a head drive control routine.

### DESCRIPTION OF EXEMPLARY EMBODIMENTS

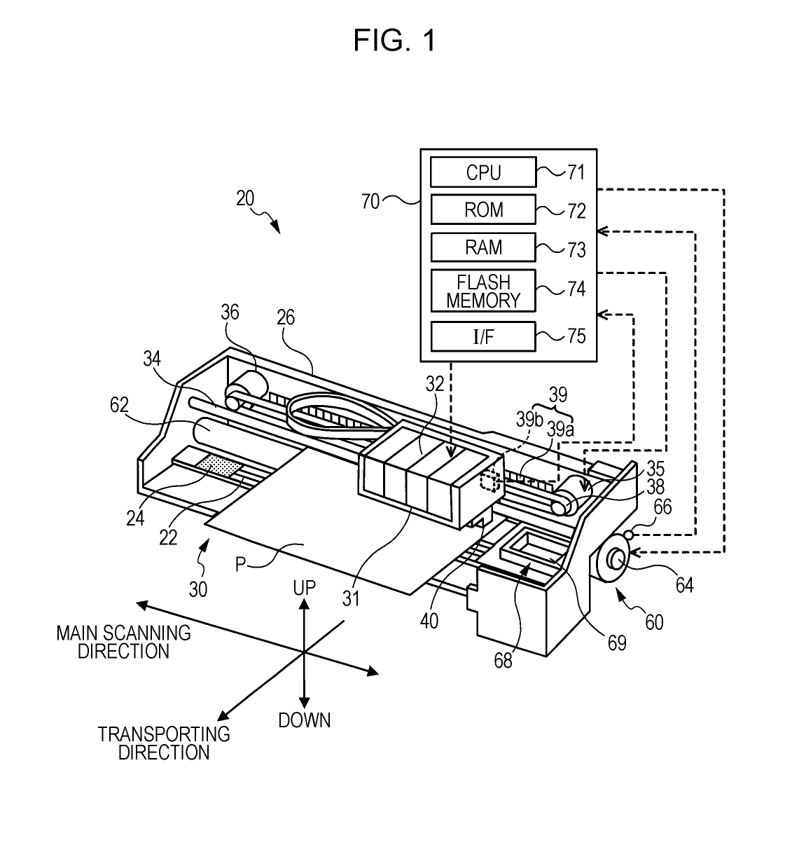

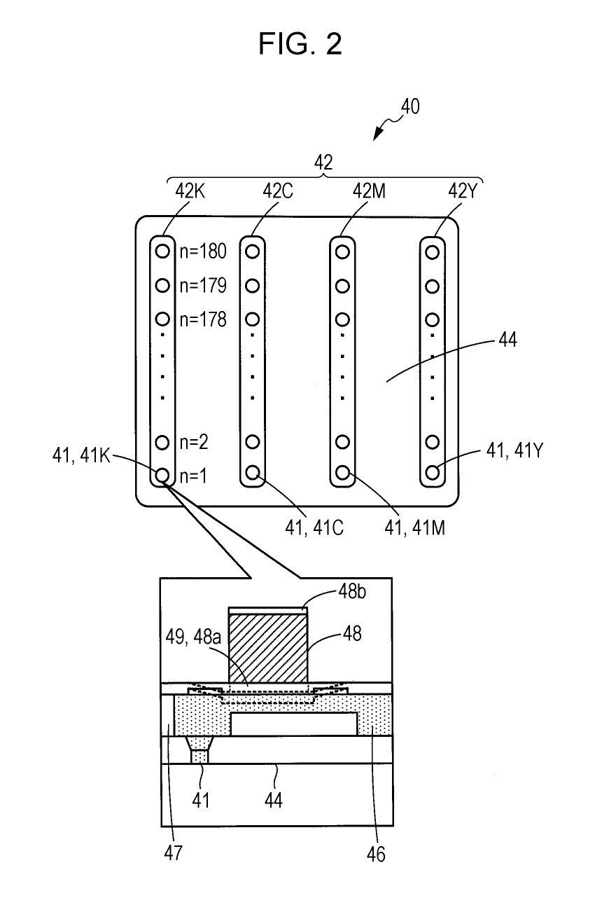

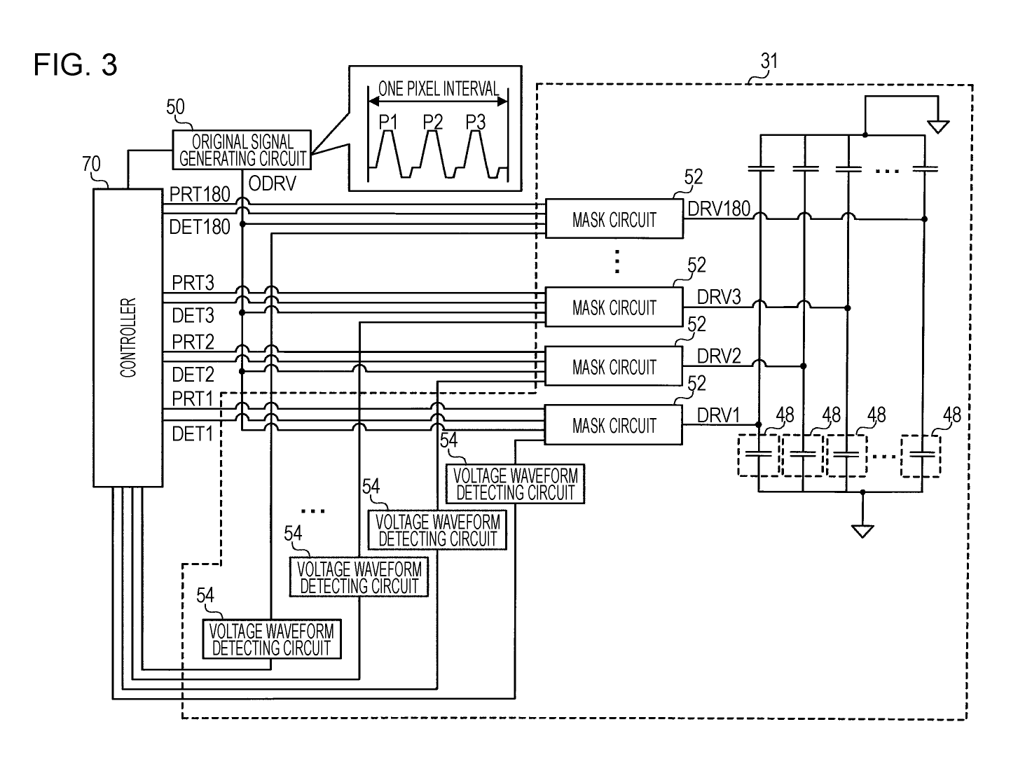

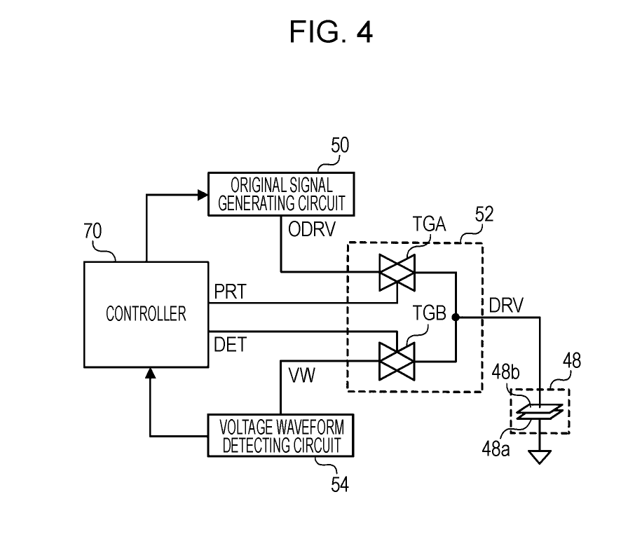

Exemplary embodiments of the invention will be described below with reference to the accompanying drawings. FIG. 1 is a configurational diagram schematically illustrating the configuration of an ink jet printer 20 according to an exemplary embodiment of the invention, FIG. 2 is a configurational diagram schematically illustrating the configuration of a printing head 40, FIG. 3 is a configurational diagram schematically illustrating the configuration of a drive circuit that drives the printing head 40, and FIG. 4 is a configurational diagram schematically illustrating the configuration of a mask circuit 52.

As illustrated in FIG. 1, the ink jet printer 20 according to the exemplary embodiment of the invention includes a sheet transporting mechanism 60 that transports a recording sheet P in a sub-scanning direction (direction frontward from the depth side in FIG. 1), a printer mechanism 30 that ejects ink droplets on the recording sheet P transported on a platen 22 by the sheet transporting mechanism 60 from nozzles formed on the printing head 40 to effect printing while moving in a main scanning direction (sideward in FIG. 1) with respect to the recording sheet P, and a controller 70 that performs the general control of the ink jet printer 20. A capping device 68 that seals the nozzle surfaces of the printing head 40 is disposed at one end of the platen 22 in the main scanning direction (right-hand end in FIG. 1). The other end of the platen 22 in the main scanning direction (left-hand end in FIG. 1) is provided with a flushing area 24 for regularly flushing out ink droplets from the nozzles of the printing head 40 to prevent clogging of the nozzles.

As illustrated in FIG. 1, the printer mechanism 30 includes a carriage 31 capable of reciprocally moving in the main scanning direction while being guided by a carriage guide 34, a carriage motor 35 disposed at one end of the carriage guide 34, a driven roller 36 disposed at other end of the carriage guide 34, a carriage belt 38 put around the carriage motor 35 and the driven roller 36, ink cartridges mounted on the carriage 31 and containing inks of individual colors, cyan (C), magenta (M), yellow (Y) and black (K), and the printing head 40 on which a plurality of nozzles 41 to apply pressure to the individual inks supplied from the respective ink cartridges 32 to eject ink droplets therefrom are formed. The carriage, 31 reciprocally moves in the main scanning direction when the carriage belt 38 is driven by the carriage motor 35. A carriage position sensor 39 that detects the position of the carriage 31 in the main scanning direction is mounted on the rear side of the carriage 31. The carriage position sensor 39 includes a linear optical scale 39a disposed along the carriage guide 34, and an optical sensor 39b, mounted on the back of the carriage 31 so as to face the optical scale 39a, to optically read the optical scale 39a.

As illustrated in FIGS. 2 and 3, the printing head 40 includes a nozzle plate 44 on which four nozzle lines 42C, 42M, 42Y and 42K of cyan (C), magenta (M), yellow (Y) and black (K) each including a plurality of nozzles 41 (180 nozzles in the exemplary embodiment) are formed, a cavity plate 47 serving as a side wall to form ink chambers 46 which communicate with the nozzles 41, piezoelectric elements 48 each having an electrode 48a grounded and a piezoelectric substance held between the electrode 48a and another electrode 48b, elastically deformable vibrating plates 49 each serving as the electrode 48a of the corresponding piezoelectric element 48 to form the top wall of the ink chamber 46, and mask circuits 52 each serving as a drive circuit to apply a drive signal (voltage) to the electrode 48b of the corresponding piezoelectric element 48. When the mask circuit 52 applies a pulse voltage to the piezoelectric element 48, the top wall (vibrating plate 49) of the ink chamber 46 is vibrated to change the inner volume of the ink chamber 46. When the contraction pressure that is generated upon contraction of the volume of the ink chamber 46 is compressed, the printing head 40 ejects the corresponding ink as ink droplets from the nozzles 41 communicating with the ink chamber 46. Since the piezoelectric element 48 has a piezoelectric substance sandwiched between the two electrodes 48a, 48b, it can be regarded as a capacitor. All of the nozzles 41C, 41M, 41Y, 41K will be generally called “nozzles 41” hereinafter, and all of the nozzle lines 42C, 42M, 42Y, 42K will be generally called “nozzle lines 42” hereinafter. Driving of the printing head 40 will be explained referring to the nozzles 41K for black (K).

As illustrated in FIG. 3, the mask circuits 52 are mounted on the carriage 31, receive original signals ODRV and print signals PRTn generated by an original signal generating circuit 50, generate drive signals DRVn based on the received original signals ODRV and print signals PRTn, and output the drive signals DRVn to the respective piezoelectric elements 48. Note that the letter “n” affixed to the ends of the print signal PRTn and the drive signal DRVn is a number specifying a nozzle included in each nozzle line, and n is any integer from “1” to “180” for each nozzle line contains 180 nozzles according to the exemplary embodiment. The original signal generating circuit 50 sends the mask circuit 52 a signal containing three pulses, namely, a first pulse P1, second pulse P2 and third pulse P3, as a repetitive unit in one pixel interval (a time during which the carriage 31 moves across one pixel interval) as the original signal ODRV. The mask circuit 52 which has received the original signal ODRV masks an unnecessary pulse in the three pulses included in the original signal ODRV based on the print signal PRTn input separately, thereby outputting only a necessary pulse as the drive signal DRVn to the piezoelectric elements 48 of the nozzles 41K. When only the first pulse P1 is output to the piezoelectric elements 48 as the drive signal DRVn at this time, one shot of ink droplets is ejected from the nozzles 41K to form dots of a small size (small dots) on the recording sheet P. When the first pulse P1 and the second pulse P2 are output to the piezoelectric elements 48, two shots of ink droplets are ejected from the nozzles 41K to form dots of an intermediate size (intermediate dots) on the recording sheet P. When the first pulse P1, the second pulse P2 and the third pulse P3 are output to the piezoelectric elements 48, three shots of ink droplets are ejected from the nozzles 41K to form dots of a large size (large dots) on the recording sheet P. In this manner, the ink jet printer 20 can form dots of three sizes by adjusting the amount of ink to be ejected in one pixel interval. The same descriptions on the nozzle 41K and the nozzle line 42K are applied to the nozzles 41C, 41M, 41Y, and the nozzle lines 42C, 42M, 42Y respectively.

As illustrated in FIG. 4, the mask circuit 52 includes two transmission gates TGA and TGB. The transmission gate TGA has a control terminal connected to an output port of the controller 70, an input terminal connected to the output terminal of the original signal generating circuit 50, and an output terminal connected to the electrode 48b of the corresponding piezoelectric element 48. When an ON signal is input to the control terminal of the transmission gate TGA from the controller 70, the transmission gate TGA electrically connects the input and output terminals together to transfer the drive signal to the electrode 48b of the piezoelectric element 48 from the original signal generating circuit 50. When an OFF signal is input to the control terminal of the transmission gate TGA from the controller 70, the transmission gate TGA electrically disconnects the input and output terminals from each other to block the transfer of the drive signal to the electrode 48b of the piezoelectric element 48 from the original signal generating circuit 50. The transmission gate TGB has a control terminal connected to another output port of the controller 70, an input terminal connected to the electrode 48b of the corresponding piezoelectric element 48, and an output terminal connected to the input terminal of the corresponding voltage waveform detecting circuit 54. When an ON signal is input to the control terminal of the transmission gate TGB from the controller 70, the transmission gate TGB electrically connects the input and output terminals together to transfer the drive signal to the voltage waveform detecting circuit 54 from the electrode 48b of the piezoelectric element 48. When an OFF signal is input to the control terminal of the transmission gate TGB from the controller 70, the transmission gate TGB electrically disconnects the input and output terminals from each other to block the transfer of the drive signal to the voltage waveform detecting circuit 54 from the electrode 48b of the piezoelectric element 48.

The piezoelectric element 48 (vibrating plate 49), the mask circuit 52 and the voltage waveform detecting circuit 54 are provided for each of the nozzles 41 as illustrated in FIGS. 2 and 3. When the piezoelectric element 48 (vibrating plate 49) is driven by the mask circuit 52, ink droplets are ejected from the corresponding nozzle 41, and the voltage waveform detecting circuit 54 detects a voltage waveform acting on the electrode 48b of the corresponding piezoelectric element 48.

The voltage waveform detecting circuit 54 detects the voltage waveform of the piezoelectric element 48 (electrode 48b) to detect residual vibration of the vibrating plate 49. Though not illustrated, the voltage waveform detecting circuit 54 may include, for example, an oscillation circuit, such as an RC oscillation circuit or LC oscillation circuit, which uses the capacitance of the piezoelectric element 48 (capacitor) as a C component, and a counter which counts the number of pulses in an oscillation signal from the oscillation circuit. When the piezoelectric element 48 is driven, the vibrating plate 49 starts vibrating, and the vibration continues (residual vibration) while being attenuated. At this time, if the viscosity of the ink in the nozzle 41 is increased, the attenuation of the vibrating plate 49 becomes faster (over-attenuated), shortening the period of residual vibration. Therefore, the viscosity of the ink in the nozzle 41 can be detected by detecting the period of residual vibration of the vibrating plate 49.

The sheet transporting mechanism 60, as illustrated in FIG. 1, includes a transporting roller 62 that transports the recording sheet P onto the platen 22, and a transporting motor 64 that rotates the transporting roller 62. The transporting motor 64 has a rotating shaft mounted with a rotary encoder 66 that detects the amount of rotation thereof. The rotation of the transporting motor 64 is controlled based on the amount of rotation given from the rotary encoder 66. The rotary encoder 66 includes, though not illustrated, a rotary scale graduated at certain rotational angular intervals, and a rotary scale sensor to read the graduations on the rotary scale.

The capping device 68 seals the nozzle, surfaces with the printing head 40 moved to a position facing the capping device 68 (what is called “home position”) to prevent inks in the nozzles from being dried, or sucks inks in the nozzles with the nozzle surfaces sealed to clean the printing head 40. The capping device 68 has a substantially rectangular parallelepiped cap 69 with an open top in order to seal the nozzle surfaces of the printing head 40, a tube (not illustrated) connected to the bottom of the cap 69, and a suction pump (not illustrated) attached to the tube. In cleaning the printing head 40, the capping device 68 drives the suction pump with the nozzle surfaces of the printing head 40 sealed with the cap 69, rendering the inner space formed by the nozzle surfaces of the printing head 40 and the cap 69 to negative pressure to forcibly suck the inks in the nozzles.

The controller 70 is configured as a microprocessor including a CPU 71 as the central unit, and includes a ROM 72 storing a processing program, a RAM 73 which temporarily stores data, a flash memory 74 which is reprogrammable and is capable of retaining data even when powered off, and an interface (I/F) 75. Data on the position of the carriage 31 from the carriage position sensor 39, the amount of rotation of the transporting roller 62 from the rotary encoder 66, etc. is input to the controller 70 via the I/F 75. The controller 70 outputs the drive signal to the printing head 40, the drive signal to the transporting motor 64, the drive signal to the carriage motor 35, the drive signal to the suction pump, etc. via the I/F 75. The controller 70 also receives a print command and print data from a user computer (PC) (not illustrated) via the I/F 75. The RAM 73 is provided with the a print buffer area where received print data is stored in the upon reception of the print data from the user PC.

When the ink jet printer 20 with the foregoing configuration according to the exemplary embodiment receives image data (e.g., JPEG data) as print data from a user PC, the controller 70 decompresses the image data, if compressed, to generate RGB data. Then, the controller 70 resizes the generated RGB data for color conversion to CMYK data, and performs half-tone processing on the color-converted CMYK data for binarization to generate print data. Then, the controller 70 outputs an original signal ODRV from the original signal generating circuit 50 to the mask circuit 52, and outputs a print signal PRTn to the mask circuit 52 based on the generated print data to apply the drive voltage to the electrode 48b of the corresponding piezoelectric element 48, causing the ink to be ejected from the corresponding nozzle 41.

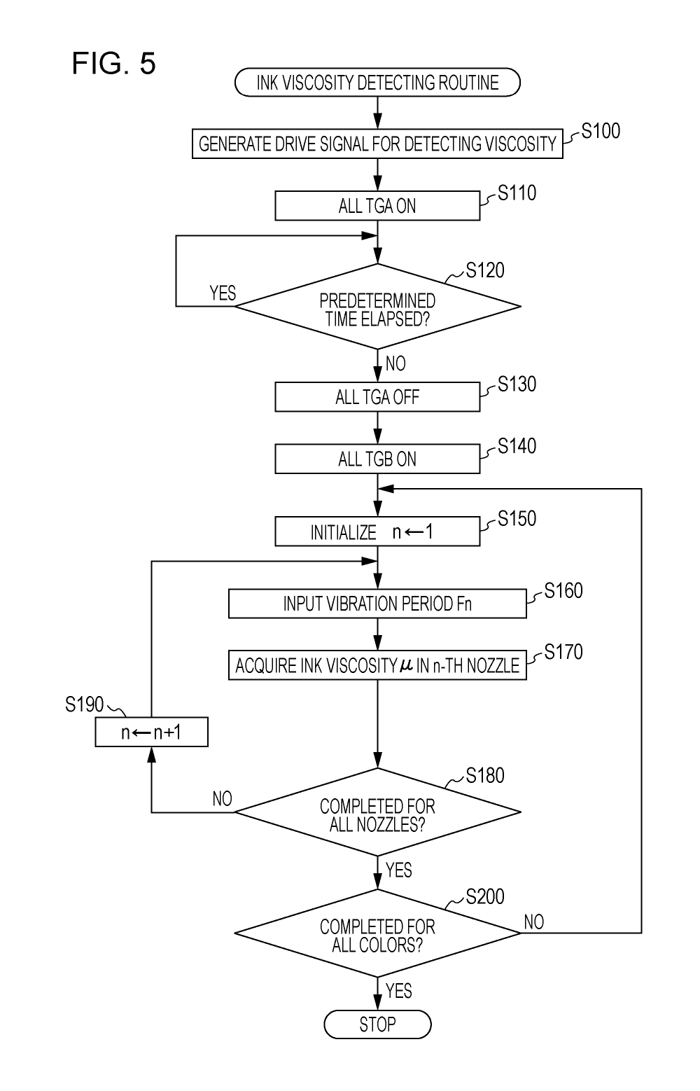

Next, a description will be given of an operation at the time of detecting the viscosity of the ink in the nozzle 41 and an operation of setting the drive voltage for the printing head 40 (piezoelectric element 48) based on the viscosity of the ink. First, the operation at the time of detecting the ink viscosity will be described. FIG. 5 is a flowchart illustrating one example of an ink viscosity detecting routine that is executed by the controller 70. This routine is executed when, for example, a print command is input from a user PC.

When the ink viscosity detecting routine is executed, the CPU 71 of the controller 70 instructs the original signal generating circuit 50 to generate a drive signal for viscosity detection first (step S100). According to the exemplary embodiment, the viscosity detection drive signal is a given generated voltage having a voltage level as high as possible within a range where ink droplets are not ejected from the nozzles 41. Then, the CPU 71 turns on the transmission gates TGA of all the mask circuits 52, and stands by until a certain time passes (steps S110, S120). When the certain time passes, the CPU 71 turns off the transmission gates TGA of all the mask circuits 52 (step 130), and turns on the transmission gates TGB of all the mask circuits 52 (step S140). The ON/OFF switching of the transmission gates TGA causes a pulse voltage with a sharp rise to act on the piezoelectric elements 48, so that the vibrating plates 49 vibrate with attenuation. Because the transmission gates TGB are turned on at this time, the vibration of the vibrating plates 49 allows the corresponding voltage waveform detecting circuit 54 for each piezoelectric element 48 to detect a vibration period Fn of the voltage generated on the electrode 48b of the piezoelectric element 48 (capacitor). Subsequently, the nozzle number n is initialized to “1” (step S150), and the vibration period Fn of the voltage acting on the piezoelectric element 48 (electrode 48b) corresponding to the nozzle 41 with the nozzle number n is input from the corresponding voltage waveform detecting circuit 54 (step S160). The ink viscosity μ of the ink in the nozzle 41 with the nozzle number n is acquired from the input vibration period Fn (step S170). As mentioned above, the shorter the vibration period Fn, the higher the ink viscosity μ. According to the exemplary embodiment, the relation between the vibration period Fn and the ink viscosity μ is acquired beforehand and is stored as a map in the ROM 72, so that with the vibration period Fn given, the corresponding ink viscosity μ is acquired from the map. Then, the CPU 71 determines whether the acquisition of the ink viscosity μ is completed for all the nozzles (whether n is “180” for there are 180 nozzles 41 for each color according to the exemplary embodiment) (step S180). When it is determined that the acquisition of the ink viscosity μ is not completed for all the nozzles, the nozzle number n is incremented by “1” (step S190), and the CPU 71 returns to step S160 to repeat the processes of steps S150 to S190 to acquire the ink viscosity μ for a next nozzle 41. When it is determined that the acquisition of the ink viscosity μ is completed for all the nozzles, the CPU 71 determines whether the acquisition of the ink viscosity μ is completed for all the colors (step S200). When it is determined that the acquisition of the ink viscosity μ is not completed for all the colors, the CPU 71 returns to step S150 to repeat the processes of steps S150 to S190 to acquire the ink viscosity μ for every nozzle 41 for a next color. When it is determined that the acquisition of the ink viscosity μ is completed for all the colors, the CPU 71 terminates the routine.

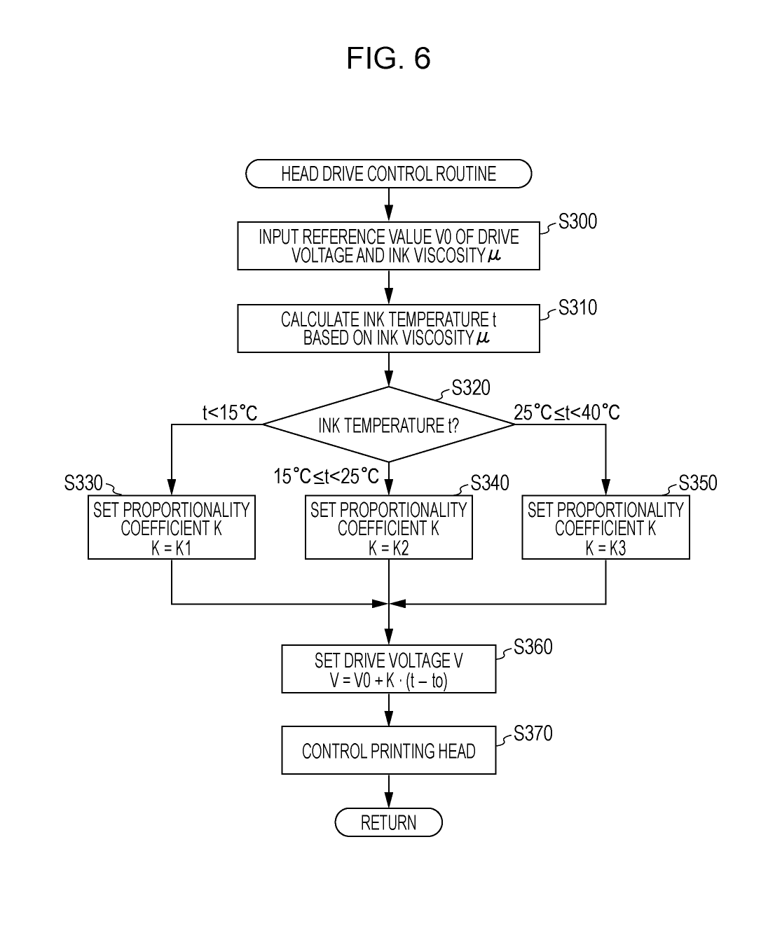

Next, a process of setting the drive voltage for the printing head 40 based on the temperature of the acquired ink viscosity μ will be described below. FIG. 6 is a flowchart illustrating one example of a drive voltage setting routine which is executed by the controller 70 according to the embodiment. This routine is carried out for each nozzle 41 at a timing at which ink is ejected from the nozzle 41 at the time of printing an image.

When the drive voltage setting routine is executed, the CPU 71 of the controller 70 first inputs a reference value V0 of the drive voltage and the ink viscosity μ (step S300), and calculates an ink temperature t from the following equation 1 based on the input ink viscosity μ (step S310). The reference value V0 of the drive voltage is a drive voltage suitable at a standard temperature t0 (e.g., 15° C.). The equation 1 is a correlation equation representing the correlation between the viscosity of water or a solvent for ink and the water temperature.

$$μ = \frac{0.1}{2.1482 \cdot ( t - 8.435 + \sqrt{8078.4 + {( t - 8.435 )}^{2}} ) - 120} \qquad ( 1 )$$

where μ represents the viscosity (Pa·s), and t represents water temperature (° C.).

After calculating the ink temperature t, the CPU 71 determines whether the calculated ink temperature t is less than 15° C., is equal to or higher than 15° C. and less than 25° C., or is equal to or higher than 25° C. and less than 40° C. which is the upper limit in the usable range (step S320). When the calculated ink temperature t is less than 15° C., a positive first value K1 is set to a proportionality coefficient K (step S330). When the calculated ink temperature t is equal to or higher than 15° C. and less than 25° C., a positive second value K2 is set to the proportionality coefficient K (step S340). When the calculated ink temperature t is equal to or higher than 25° C. and less than 40° C., a positive third value K3 is set to the proportionality coefficient K (step S350). Then, the CPU 71 sets a drive voltage V according to the following equation 2 using the input reference value V0 of the drive voltage, the calculated ink temperature t and the set proportionality coefficient K (step S360). The CPU 71 controls driving of the printing head 40 with the set drive voltage V (step S370), and then terminates the routine. The drive control of the printing head 40 is carried out by causing the original signal generating circuit 50 to generate the original signal ODRV so that the set drive voltage V is applied to the electrode 48b of the corresponding piezoelectric element 48, generating a print signal PRT based on print data, and outputting the original signal ODRV and the print signal PRT to the corresponding mask circuit 52. As apparent from the equation 2, the drive voltage V is a reference value V0 added with a correction term which is proportional to the ink temperature t by the proportionality coefficient K (>0). Therefore, the drive voltage V is corrected to become higher as the ink temperature t becomes higher. The first value K1, the second value K2 and the third value K3 which become the proportionality coefficient K are suitable values in the zone where the ink temperature t is less than 15° C., in the zone where the ink temperature t is equal to or higher than 15° C. and less than 25° C., and in the zone where the ink temperature t is equal to or higher than 25° C. and less than 40° C., respectively, and can be set to different values for the respective zones such that, for example, the third value K3 is larger than the second value K2, and the second value K2 is larger than the first value K1. As apparent from the equation 1, the ink viscosity μ becomes 0.00114±0.00001 Pa·s when the ink temperature t is 15° C., becomes 0.00089±0.00001 Pa·s when the ink temperature t is 25° C., and becomes 0.00065±0.00001 Pa·s when the ink temperature t is 40° C., so that the lower the ink viscosity the higher the drive voltage V, and it can be said that the increasing ratio differs zone by zone for the three zones with the foregoing viscosities being the boundaries.

V=V0+K·(t−t0) (2)

According to the exemplary embodiment, when the ink temperature t exceeds the usable range, i.e., when the ink viscosity μ exceeds the allowable range, flushing is carried out to control the driving of the carriage motor 35 to move the printing head 40 to a position where the nozzle surfaces face the flushing area 24, and to eject ink droplets from the nozzle 41 whose ink viscosity μ exceeds the allowable range toward the flushing area 24, or a cleaning process is carried out to seal the printing head 40 with the capping device 68, and drive the pump (not illustrated) to set the sealed interior to negative pressure to thereby forcibly suck the ink in the nozzle 41.

The correlation between the components of the exemplary embodiment and the components of the invention is illustrated below. The piezoelectric element 48 corresponds to the “piezoelectric element”, the nozzle 41 corresponds to the “nozzle”, the transmission gate TGB, the voltage waveform detecting circuit 54 and the controller 70 which executes the viscosity detecting routine in FIG. 5 correspond to the “viscosity estimating unit”, the controller 70 which executes the processing of steps S300 to S360 in the head drive control routine in FIG. 6 corresponds to the “drive voltage setting unit”, and the controller 70 which executes the processing of step S370 in the head drive control routine in FIG. 6 corresponds to the “drive control unit”.

The ink jet printer 20 according to the exemplary embodiment described above calculates the ink temperature t based on the ink viscosity μ, separates the usable range to three zones, namely, the zone where the ink temperature t is less than 15° C., the zone where the ink temperature t is equal to or higher than 15° C. and less than 25° C., and the zone where the ink temperature t is equal to or higher than 25° C. and less than 40° C., sets different proportionality coefficients K for the respective zones of the ink temperature t, sets the drive voltage for the printing head (piezoelectric elements 48) by adding the proportional term which is proportional to the ink temperature t by the proportionality coefficient K to the reference value V0 of the drive voltage. Accordingly, the ink jet printer 20 can set a more adequate drive voltage V based on the ink viscosity μ, thus ensuring accurate ejection of ink.

Although the usable range is separated to three zones, namely, the zone where the ink temperature t is less than 15° C., the zone where the ink temperature t is equal to or higher than 15° C. and less than 25° C., and the zone where the ink temperature t is equal to or higher than 25° C. and less than 40° C., and the drive voltage V is set from the equation 2 using different proportionality coefficients K set for the respective zones of the ink temperature t according to the foregoing exemplary embodiment, the usable range may be separated to two zones for which different proportionality coefficients K are set respectively, or the usable range may be separated to four or more zones for which different proportionality coefficients K are set respectively.

Although the drive voltage V for the piezoelectric elements 48 is set by adding the proportional term proportional to the ink temperature t by the proportionality coefficient K, which differs from one zone in the usable range of the ink temperature t to another, to the reference value V0 of the drive voltage according to the foregoing exemplary embodiment, a correction voltage may be set for each zone in the usable range so that the correction voltage becomes higher for a zone where the ink temperature t is higher, and the correction voltage corresponding to the zone of the ink temperature t may be acquired and added to the reference value V0 of the drive voltage to set the drive voltage V.

Although the ink temperature t is calculated from the equation 1 based on the ink viscosity μ, and the drive voltage V is calculated based on the calculated ink temperature t according to the foregoing exemplary embodiment, the drive voltage V may be calculated directly from the ink viscosity μ.

Although the fluid ejecting apparatus of the invention is worked out in the form of the printer 20 according to the foregoing exemplary embodiment, the fluid ejecting apparatus may be embodied into a fluid ejecting apparatus which ejects a fluid other than ink, or a fluid substance such as a liquid substance (dispersion liquid) containing particles of a functional material dispersed therein, or gel, or may be embodied into a fluid ejecting apparatus which ejects an ejectable solid material as a fluid. Examples of such fluid ejecting apparatuses include a liquid ejecting apparatus which ejects a liquid in which an electrode material or color material used in fabricating a liquid crystal display, an EL (Electroluminescence) display and a surface emitting display is dissolved, a liquid ejecting apparatus which ejects a liquid substance having the above material dispersed therein, and a liquid ejecting apparatus which ejects a liquid which is used as a precise pipette to become a sample. The fluid ejecting apparatus according to the exemplary embodiment of the invention may be worked out as a liquid ejecting apparatus which ejects a lubricant to a precision machine like a clock or camera in pin point, a liquid ejecting apparatus which ejects a transparent resin liquid like ultraviolet curing resin for forming micro hemispherical lenses (optical lenses) or the like, which are used in optical communication devices or the like, onto a substrate, a liquid ejecting apparatus which ejects an etchant such as acid or alkaline for etching a substrate or the like, a liquid ejecting apparatus which ejects a gel, or a powder-ejection type recording apparatus which ejects powder like toner.

Although the fluid ejecting apparatus according to the invention is adapted to the ink jet printer 20 according to the exemplary embodiment, the fluid ejecting apparatus may be adapted to any image forming apparatus capable of forming an image on a medium, such as a multifunction printer which is equipped with a scanner or the like in addition to a printer, or a facsimile apparatus.

It is to be noted that the invention is not limited to the foregoing exemplary embodiment, and may be worked out in various forms within the technical scope and spirit of the invention.

What is claimed is:

1. A fluid ejecting apparatus that compresses a fluid by driving piezoelectric elements to thereby eject the fluid from nozzles, the fluid ejecting apparatus comprising:
a voltage waveform detecting unit detects a voltage waveform of the piezoelectric element,
a viscosity estimating unit that estimates a viscosity of the fluid according to the voltage waveform detecting unit;
a drive voltage setting unit that sets a drive voltage for the piezoelectric elements based on the estimated viscosity; and
a drive control unit that controls driving of the piezoelectric elements according to the set drive voltage,
wherein the drive voltage increases with a decrease in the estimated viscosity.

2. The fluid ejecting apparatus according to claim 1,
wherein the drive voltage increases with a decrease in viscosity by different increasing ratios in two or more zones respectively with a predetermined viscosity being a boundary therebetween.

3. The fluid ejecting apparatus according to claim 1, wherein the drive voltage increases with a decrease in viscosity by a first increasing ratio in a first zone where the viscosity is less than the predetermined viscosity, and the drive voltage increases with a decrease in viscosity by a second increasing ratio larger than the first increasing ratio in a second zone where the viscosity is equal to or higher than the predetermined viscosity.

4. The fluid ejecting apparatus according to claim 1, wherein the drive voltage increases with an increase in temperature by different increasing ratios in two or more zones respectively with a predetermined temperature being a boundary therebetween, and
the drive voltage setting unit calculates a temperature of the fluid based on the estimated viscosity of the fluid, and sets the drive voltage for the piezoelectric elements based on the calculated temperature of the fluid.

5. A fluid ejecting apparatus that compresses a fluid by driving piezoelectric elements to thereby eject the fluid from nozzles, the fluid ejecting apparatus comprising:
a viscosity estimating unit that estimates a viscosity of the fluid;
a drive voltage setting unit that sets a drive voltage included in different voltages respectively determined beforehand for zones with a predetermined viscosity being a boundary therebetween, and corresponding to a zone to which the estimated viscosity belongs, as the drive voltage for the piezoelectric elements; and
a drive control unit that controls driving of the piezoelectric elements according to the set drive voltage.

6. The fluid ejecting apparatus according to claim 2, wherein the predetermined viscosity is set to 0.00114±0.00001 Pa·s which is a viscosity when the temperature of the fluid is 15° C.

7. The fluid ejecting apparatus according to claim 2, wherein the predetermined viscosity is set to 0.00089±0.00001 Pa·s which is a viscosity when the temperature of the fluid is 25° C.

8. The fluid ejecting apparatus according to claim 2, wherein the predetermined viscosity is set to 0.00065±0.00001 Pa·s which is a viscosity when the temperature of the fluid is 40° C.
